(19) United States
(12) Patent Application Publication
(10) Pub. No.: US 2012/0133631 A1
(43) Pub. Date: May 31, 2012

(54) SOURCE DRIVER OUTPUT CIRCUIT OF FLAT PANEL DISPLAY DEVICE

(75) Inventors: Hun-Yong Lim, Daejeon-si (KR); Ji-Hun Kim, Daejeon-si (KR); Hyun-Min Song, Cheongju-si (KR); Sang-Woo Kim, Daejeon-si (KR); Joon-Ho Na, Daejeon-si (KR)

(73) Assignee: SILICON WORKS CO., LTD, Daejeon-si (KR)

(21) Appl. No.: 13/301,101

(22) Filed: Nov. 21, 2011

(30) Foreign Application Priority Data
Nov. 26, 2010 (KR) 10-2010-0118857

(51) Int. Cl. G09G 5/00

(52) U.S. Cl. 345/211

(57) ABSTRACT

In a source driver output circuit of a flat panel display device, first and second latch units receive image data and store the received image data. A D/A converter converts the image data into a data voltage. An output buffer unit outputs the data voltage to a data line. A switching control unit decides whether or not the data voltages of two image data of the same channel among image data of horizontal lines adjacent to each other, stored in the first and second latch units, belong to the same grayscale voltage range, and outputs a switching control signal based on the decided result. A multiplexer unit selects a pre-charge voltage in response to the switching control signal or continuously maintains a connection state between a corresponding channel of the output buffer unit and the corresponding data line.

### BACKGROUND OF THE INVENTION

1. Field of the Invention

The present invention relates to a driving technique of a flat panel display device, and more particularly, to a source driver output circuit of a flat panel display device, which can appropriately control a pre-charging operation when a source driver outputs a data voltage for driving a display panel.

2. Description of the Related Art

Recently, flat panel display devices such as a liquid crystal display (LCD), a plasma display panel (PDP) and an organic light emitting diode (OLED) panel have been widely spread and used. Among these flat panel display devices, the LCD has been more widely spread.

As a representative example of the flat panel display devices, the LCD includes a display panel having a matrix-type pixel area in which a plurality of gate lines and a plurality of data lines are aligned in directions vertical to each other, a driving circuit unit for supplying driving signals and data signals to the display panel, and a backlight for providing a light source to the display panel.

The driving circuit unit includes a source driver for supplying a data signal to each of the data lines of the display panel, a gate driver for applying a gate driving pulse to each of the gate lines of the display panel, a timing controller for receiving control signals such as display data, vertical and horizontal synchronization signals and a clock signal, inputted from a driving system of the display panel so as to outputs the received control signals at timing suitable for the source and gate drivers to reproduce an image, and the like.

FIG. 1 is a waveform diagram of an input/output signal of a source driver according to a related art. Referring to FIG. 1, when a data voltage (grayscale voltage) V_{DATA} is supplied to a corresponding data line of a display panel corresponding to positive image data, the source driver rises the data voltage from a minimum voltage Min to a maximum voltage Max in synchronization with a rising edge of a load signal LOAD.

Subsequently, when the data voltage V_{DATA} is supplied to a corresponding data line of the display panel corresponding to consecutive negative image data, the source driver drops the data voltage from the maximum voltage Max to the minimum voltage Min, and then continuously maintains the minimum voltage Min.

According to the related art, when a data voltage is supplied corresponding to image data having different polarities from each other, the swing width of the data voltage is large, and therefore, power consumption and calorific value are increased.

FIG. 2 is a waveform diagram of an input/output signal of a source driver according to another related art. Referring to FIG. 2, when a data voltage (grayscale voltage) V_{DATA} is supplied to a corresponding data line of a display panel corresponding to positive image data, the source driver pre-charges the data voltage up to an intermediate voltage ½ VDD corresponding to the intermediate between the minimum voltage Min and the maximum voltage Max in a ‘high’ period of the load signal LOAD using an external voltage, and then rises the pre-charged data voltage up to the maximum voltage Max. Subsequently, when the data voltage V_{DATA} is supplied to a corresponding data line of the display panel corresponding to consecutive negative image data, the source driver, as described above, pre-charges the data voltage up to the intermediate voltage ½ VDD in a ‘high’ period of the load signal LOAD using an external voltage, and then drops the pre-charged data voltage down to the minimum voltage Min. The source driver consecutively performs the aforementioned operations.

In this case, the swing width of the data voltage is approximately half as compared with that in the related art described with reference to FIG. 1, and accordingly, power consumption and calorific value are decreased. However, the driver source unnecessarily performs a pre-charging operation even when the polarities of previous and current image data are identical to each other. Therefore, power is wasted, and the slew rate of the data voltage is decreased.

### SUMMARY OF THE INVENTION

Accordingly, the present invention has been made in an effort to solve the problems occurring in the related art, and an object of the present invention is to provide a source driver output circuit of a flat panel display device, in which when a source driver of the flat panel display device outputs a data voltage for driving a display panel, the driver source performs a pre-charging operation when the data voltage is changed from an upper grayscale voltage to a lower grayscale voltage or changed from the lower grayscale voltage to the upper grayscale voltage, but the driver source omits the pre-charging operation and continuously maintains a previous connection state when the data voltage is maintained from the upper grayscale voltage to the upper grayscale voltage or maintained from the lower grayscale voltage to the lower grayscale voltage.

Another object of the present invention is to provide a source driver output circuit of a flat panel display device, in which when a source driver of the flat panel display device outputs a data voltage for driving a display panel, the driver source pre-charges the data voltage to an intermediate voltage supplied from the outside when the data voltage is an upper grayscale voltage, and pre-charges the data voltage to a ground voltage when the data voltage is a lower grayscale voltage.

In order to achieve the above object, according to one aspect of the present invention, there is provided a source driver output circuit of a flat panel display device, including: a first latch unit configured to receive image data from a data register unit and store the received image data; a second latch unit configured to receive the image data from the first latch unit and store the received image data; a D/A converter configured to convert the image data of the second latch unit into a data voltage; an output buffer unit configured to output the data voltage of the D/A converter to a data line; a switching control unit configured to decide whether or not the data voltages of two image data of the same channel among image data of horizontal lines adjacent to each other, stored in the first and second latch units, belong to the same grayscale voltage range, and output a switching control signal based on the decided result; and a multiplexer unit configured to select a pre-charge voltage in response to the switching control signal and output the selected pre-charge voltage to the data line, or maintain a connection state between a corresponding channel of the output buffer unit and the corresponding data line, in place of selecting the pre-charge voltage.

According to another aspect of the present invention, there is provided a source driver output circuit of a flat panel display device, including: a latch unit configured to receive image data from a data register unit and store the received image data; a D/A converter configured to convert the image data of the latch unit into a data voltage; an output buffer unit configured to output the data voltage of the D/A converter to a data line; a switching control unit configured to decide whether the data voltages of the image data stored in the latch unit belongs to an upper grayscale voltage range or a lower grayscale voltage range, and output a switching control signal based on the decided result; and a multiplexer unit configured to select a first or second voltage as a pre-charge voltage and output the selected voltage to the data line, in response to the switching control signal.

### BRIEF DESCRIPTION OF THE DRAWINGS

The above objects, and other features and advantages of the present invention will become more apparent after a reading of the following detailed description taken in conjunction with the drawings, in which:

FIG. 1 is a waveform diagram of a grayscale voltage of a source driver according to a related art;

FIG. 2 is a waveform diagram of a data voltage of a source driver according to another related art;

FIG. 3 is a block diagram of a source driver output circuit of a liquid crystal display according to an embodiment of the present invention;

FIG. 4 shows a logic table for controlling a switching operation of a multiplexer unit using a switching control unit shown in FIG. 3;

FIGS. 5(a) and 5(b) are exemplary views showing a state that the switching control unit shown in FIG. 3 controls the switching operation of the multiplexer unit;

FIG. 6 is a waveform diagram of a grayscale voltage of a source driver shown in FIG. 3;

FIG. 7 is a block diagram of a source driver output circuit of a display device according to another embodiment of the present invention;

FIGS. 8(a) to 8(c) are exemplary views showing a state that a switching control unit controls a switching operation of a multiplexer unit; and

FIG. 9 is a waveform diagram of a data voltage of a source driver shown in FIG. 7.

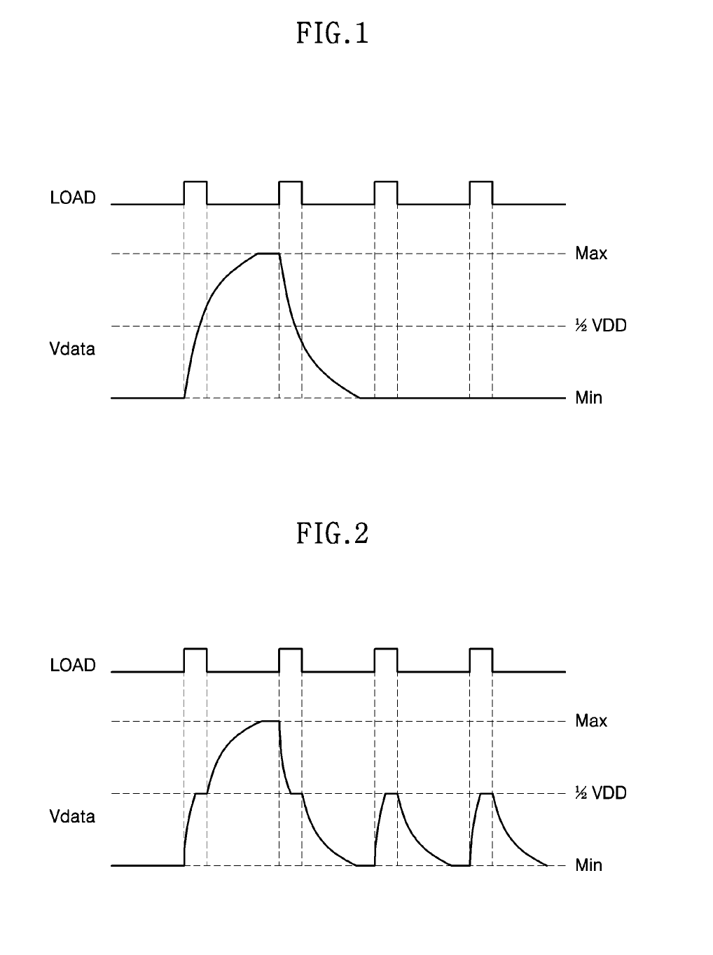

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

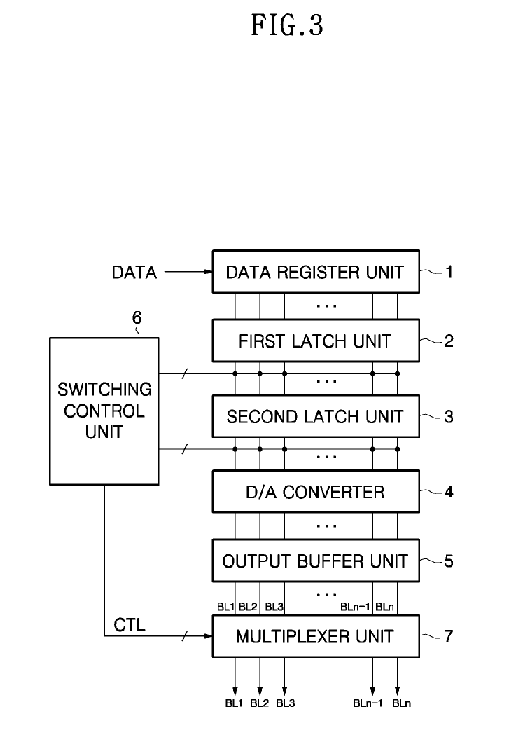

FIG. 3 is a block diagram of a source driver output circuit of a liquid crystal display according to an embodiment of the present invention. As shown in FIG. 3, the source driver output circuit includes a data register unit 1, a first latch unit 2, a second latch unit 3, a D/A converter 4, an output buffer unit 5, a switching control unit 6 and a multiplexer unit 7. The flat panel display device includes a display device having a display panel such as a liquid crystal display (LCD) panel or an organic light emitting diode (OLED) panel.

The data register unit 1 repeatedly performs an operation of storing RGB image data DATA of each channel, supplied from a timing controller (not shown), one by one in response to a shifted pulse. If image data having an amount of one horizontal line are all stored, the data register unit 1 simultaneously outputs the stored image data to the first latch unit 2.

The first latch unit 2 temporarily stores image data having an amount of the one horizontal line, applied from the data register 1 and then outputs the stored image data to the second latch unit 3.

The second latch unit 3 temporarily stores image data having an amount of the one horizontal line, applied from the first latch unit 2 and then outputs the stored image data to the D/A converter 4.

Therefore, the image data having the amount of the one horizontal line is stored in each of the first and second latch units 2 and 3 at the same time. The image data stored in each of the first and second latch units 2 and 3 contains a grayscale range bit. The grayscale range bit is a bit indicating whether the data voltage corresponding to image data belongs to an upper grayscale voltage range or belongs to a lower grayscale voltage range. The grayscale range bit may be a most significant bit (MSB) of image data, but the present invention is not limited thereto. For example, the grayscale range bit includes an MSB of image data, and may further include at least one bit consecutively adjacent to the MSB.

Hereinafter, in this embodiment, it will be illustrated that the data voltage of image data belongs to the lower grayscale voltage range when the grayscale range bit of the image data is ‘0,’ and the data voltage of the image data belongs to the upper grayscale voltage range when the grayscale range bit of the image data is ‘1.’

The D/A converter 4 selects a data voltage (grayscale voltage) corresponding to the image data inputted from the second latch unit 3 among grayscale voltages having a predetermined level, generated from a gamma reference voltage inputted from the outside, and outputs the selected data voltage to the output buffer unit 5. The data voltage is a voltage corresponding to the image data among the grayscale voltages having a predetermined level within the range from a minimum voltage Min to a maximum voltage Max. The range of the data voltage may be divided into a lower grayscale voltage range having a range of an intermediate voltage from the minimum voltage Min and an upper grayscale voltage range having a range of the maximum voltage Max from the intermediate voltage. The intermediate voltage is a voltage greater than the minimum voltage and smaller than the maximum voltage. Preferably, the intermediate voltage is (Max+Min)/2.

In a case where the display panel is an LCD panel, the upper grayscale voltage range may be a range to which the data voltage corresponding to positive data belongs, and the lower grayscale voltage range may be a range to which the data voltage corresponding to negative data belongs.

The output buffer unit 5 buffers and amplifies data voltage of each channel, applied from the D/A converter 4, and outputs the buffered and amplified data voltage to the multiplexer unit 7.

When outputting the data voltage of each channel, applied from the output buffer unit 5, to data lines DL1 to DLn of the display panel, the multiplexer unit 7 pre-charges the data voltage in a corresponding data line or maintains a previous state output under the control of a switching control signal CTL outputted from the switching control unit 6 during a load signal enable period ‘H.’ This will be described in detail as follows.

The switching control unit 6 and the multiplexer unit 7 operate in the same manner with respect to all the data lines DL1 to DLn of the display panel. Here, it will be described as an example that the switching control unit 6 and the multiplexer unit 7 operate with respect to one data line DL1.

The switching control unit 6 compares the grayscale range bits of two image data of the same channel among the image data stored in the first and second latch units 2 and 3, i.e., image data Dt of a current horizontal line, stored in the first latch unit 2, and image data Dt-1 of a just previous horizontal line, stored in the second latch unit 3, and decides whether the data voltages of the two image data Dt-1 and Dt belong to the same grayscale voltage range or belong to different grayscale voltage ranges from each other. Then, the switching control unit 6 generates a switching control signal CTL based on the decided result and outputs the generated switching control signal CTL to the multiplexer unit 7. For example, the switching control unit 6 may be configured to generate the switching control signal CTL by performing an Exclusive OR operation on the grayscale range bits of the two image data Dt-1 and Dt.

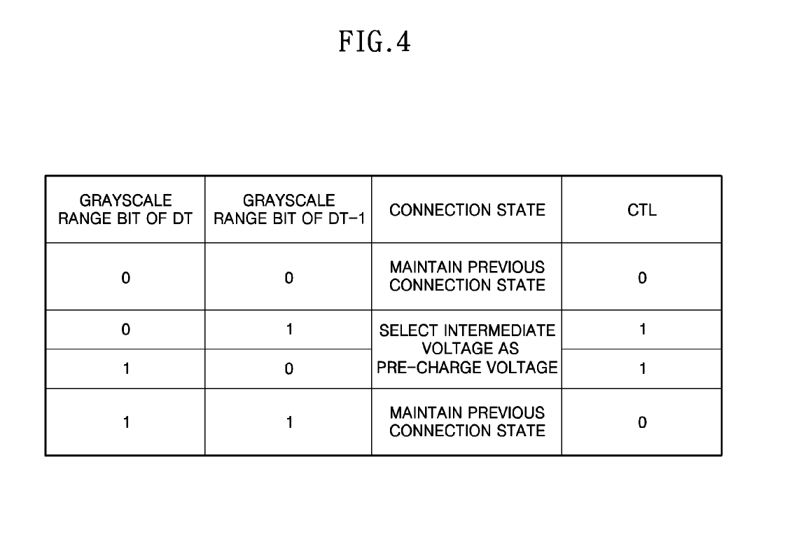

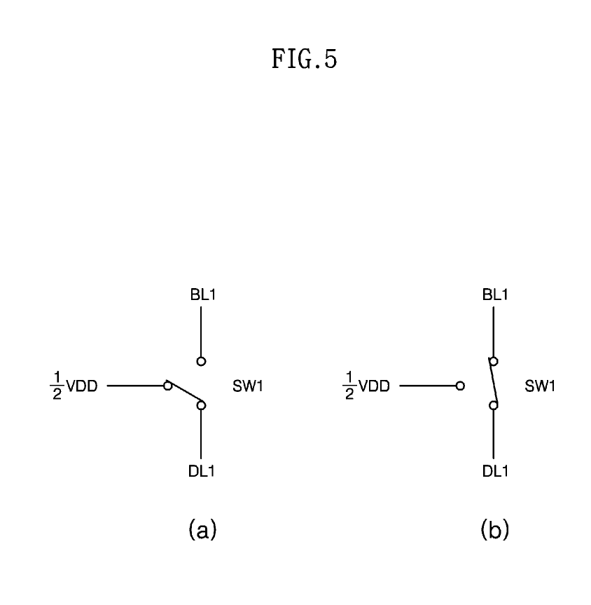

FIG. 4 is a logic table for controlling a switching operation of the multiplexer unit 7 by comparing the two image data using the switching control unit 6. FIG. 5 is an exemplary view illustrating the switching operation of the multiplexer unit 7. In FIG. 5, the maximum voltage is a power source voltage VDD, the minimum voltage is 0V, and the intermediate voltage is VDD/2. The multiplexer unit 7 includes a switch SW1 for selectively connecting a buffer output line BL1 of the output buffer unit 5 to the intermediate voltage VDD/2 or the data line DL1 in response to the switching control signal CTL.

Referring to FIGS. 4 and 5, if the grayscale range bits of the two image data Dt and Dt-1 are 0, 0 or 1, 1, respectively, the switching control unit 6 disables the switching control signal CTL as ‘0’ by performing an Exclusive OR operation on the grayscale range bits of the two image data Dt and Dt-1. If the grayscale range bits of the two image data Dt and Dt-1 are 0, 0, respectively, the data voltages of the two image data Dt and Dt-1 all belong to the lower grayscale voltage range. If the grayscale range bits of the two image data Dt and Dt-1 are 1, 1, respectively, the data voltages of the two image data Dt and Dt-1 all belong to the upper grayscale voltage range.

If the data voltages of the two image data Dt and Dt-1 all belong to the same grayscale voltage range and thus the switching control signal CTL is disabled, the switch SW1 of the multiplexer unit 7 connects the buffer output line BL1 of the output buffer unit 5 to the data line DL1 in response to the switching control signal CTL. Thus, the output buffer unit 5 can outputs a previous output to the data line DL1. FIG. 5(b) shows the aforementioned state of the switch.

Next, if the grayscale range bits of the two image data Dt and Dt-1 are 0, 0 or 1, 1, respectively, the switching control unit 6 enables the switching control signal CTL as ‘1’ by performing an Exclusive OR on the grayscale range bits of the two image data Dt and Dt-1. If the grayscale range bits of the two image data Dt and Dt-1 are 0, 1, the data voltage of the current image data Dt belongs to the lower grayscale voltage range, and the data voltage of the previous image data Dt-1 belongs to the upper grayscale voltage range. If the grayscale range bits of the two image data Dt and Dt-1 are 1, 0, the data voltage of the current image data Dt belongs to the upper grayscale voltage range, and the data voltage of the previous image data Dt-1 belongs to the lower grayscale voltage range.

If the data voltages of the two image data Dt and Dt-1 belong to different grayscale voltage ranges and thus the switching control signal CTL is enabled, the switch SW1 of the multiplexer unit 7 pre-charges the data line DL1 by applying the intermediate voltage VDD/2 to the data line DL1 in response to the switching control signal CTL. FIG. 5(a) shows the aforementioned state of the switch.

When outputting the switching control signal CTL to the multiplexer unit 7, the switching control unit 6 preferably synchronizes the switching control signal CTL with a load signal LOAD and outputs the synchronized switching control signal so that the data voltages of the image data outputted through the first and second latch units 2 and 3 are synchronized and outputted at the time when the data voltages are applied to the multiplexer unit 7.

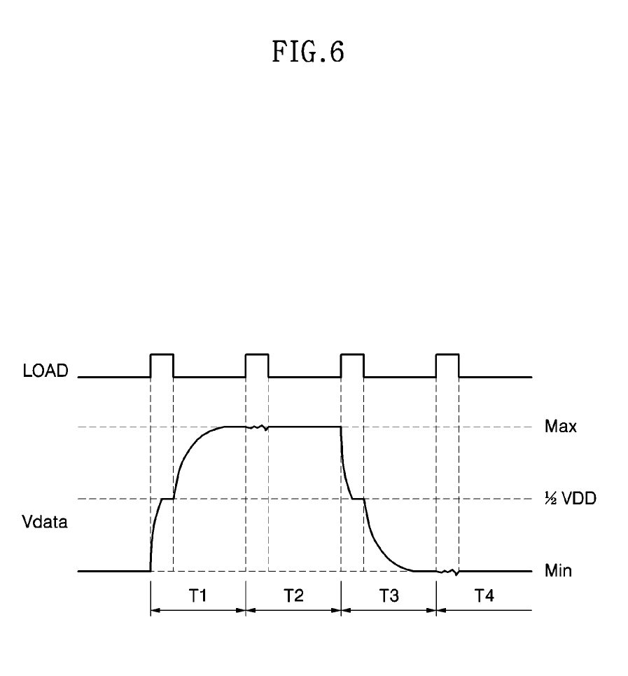

FIG. 6 is a waveform diagram showing a change in voltage applied to a data line when consecutive image data are inputted in the source driver according to the embodiment of the present invention. In FIG. 6, the consecutive image data illustrates that after image data with the minimum voltage Min is inputted, image data with the maximum voltage Max is inputted during period T1, the image data with the maximum voltage Max is inputted during period T2, the image data with the minimum voltage Min is inputted during period T3, and the image data with the minimum voltage Min is inputted during period T4.

Referring to FIG. 6, in the period T1, the data voltage of the previous image data is the minimum voltage Min, and the data voltage of the current image data is the maximum voltage Max. Therefore, the MSB of the previous image data is 0, and the MSB of the current image data is 1.

The switching control unit 6 enables the switching control signal CTL by performing an Exclusive OR operation on the MSB 0 of the previous image data and the MSB 1 of the current image data, and provides the enabled switching control signal to the multiplexer unit 7. The multiplexer unit 7 pre-charges the data line DL1 by applying the intermediate voltage VDD/2 to the data line DL1 during load signal enable period ‘H’ in response to the switching control signal CTL. The multiplexer unit 7 applies the maximum value Max that is the data voltage of the current image data to the corresponding data line DL1 during load signal disable period ‘L.’

Next, in the period T2, the previous and current image data all have the maximum voltage Max. Therefore, the MSBs of the previous and current image data all become 1.

The switching control unit 6 disables the switching control signal CTL by performing an Exclusive OR operation on the MSB 1 of the previous image data and the MSB 1 of the current image data, and provides the disabled switching control signal to the multiplexer unit 7. The multiplexer unit 7 connects the buffer output line BL1 of the output buffer unit 5 to the data line DL1 during the load signal enable period ‘H’ in response to the switching control signal CTL, so that the output of the data voltage of the previous image data is maintained. The multiplexer unit 7 applies the maximum voltage Max that is the data voltage of the current image data to the corresponding data line DL1 during the load signal disable period ‘L.’

Next, in the period T3, the data voltage of the previous image data is the maximum voltage Max, and the data voltage of the current image data is the minimum voltage Min. Therefore, the switching control signal CTL is enabled, and the corresponding data line DL1 is pre-charged with the intermediate voltage VDD/2 and then charged as the minimum voltage Min that is the data voltage of the current image data. Since the data voltages of the previous and current image data all become the minimum voltage Min in the period T4, the switching control signal CTL is disabled. The minimum voltage Min that is the data voltage of the previous image data is applied to the corresponding data line DL1 so as to be maintained, and then charged as the minimum voltage Min that is the data voltage of the current image data. From the descriptions of the periods T1 and T2, detailed descriptions of the periods T3 and T4 can be readily understood by those skilled in the art, and therefore, their detailed descriptions will be omitted.

According to this embodiment, as described in the periods T2 and T4, a pre-charging operation does not occur when consecutive image data belongs to the same grayscale voltage range, and thus it is possible to reduce power consumption and calorific value.

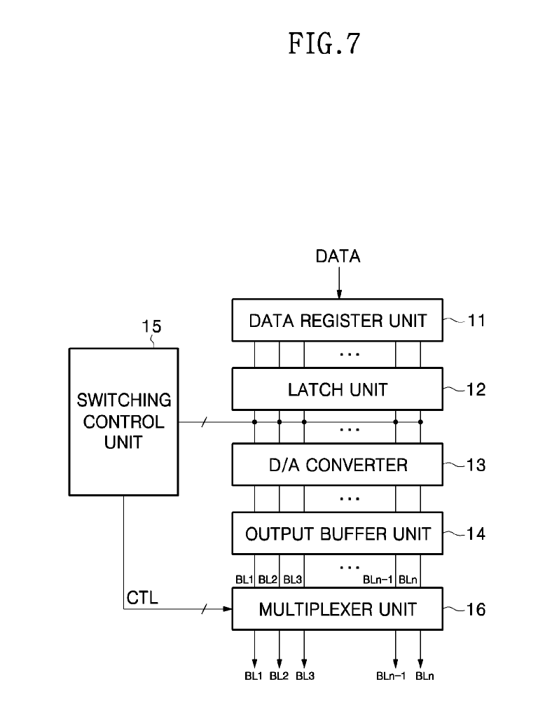

FIG. 7 is a block diagram of a source driver output circuit of a display device according to another embodiment of the present invention.

As shown in FIG. 7, the source driver output circuit includes a data register unit 11, a latch unit 12, a D/A converter 13, an output buffer unit 14, a switching control unit 15 and a multiplexer unit 16.

The latch unit 12 stores image data having an amount of one horizontal line, applied from the data register unit 11, and then outputs the stored image data to the D/A converter 13. The image data contains a grayscale range bit that indicates whether the data voltage corresponding to image data belongs to an upper grayscale voltage range or belongs to a lower grayscale voltage range. The grayscale range bit may be an MSB of the image data.

If the grayscale range bit of the image data is ‘1,’ the switching control unit 15 decides that the data voltage of the image data belongs to the upper grayscale voltage range, and changes the switching control signal CTL into a first logic state ‘1.’ If the grayscale range bit of the image data is ‘0,’ the switching control unit 15 decides that the grayscale range bit of the image data belongs to the lower grayscale voltage range, and changes the switching control signal CTL into a second logic state ‘0’ and then outputs the changed switching control signal to the multiplexer unit 16.

The multiplexer unit 16 pre-charges the data line DL1 by applying a first or second voltage to the data line DL1 in response to the switching control signal CTL during the load signal enable period ‘H.’ For example, if the switching control signal CTL is in the first logic state during the load signal enable period ‘H,’ the multiplexer unit 16 pre-charges the data line DL1 by applying the first voltage to the data line DL1. If the switching control signal CTL is in the second logic state during the load signal enable period ‘H,’ the multiplexer unit 16 pre-charges the data line DL1 by applying the second voltage to the data line DL1. The first voltage may be an intermediate voltage, and the second voltage may be a ground voltage.

The multiplexer unit 16 outputs the data voltage of the image data to the data line DL1 by connecting the buffer output line BL1 of the output buffer unit 14 to the data line DL1 during the load signal disable period ‘L.’

From the descriptions of the data register unit 1, the D/A converter 4 and the output buffer unit 5 of FIG. 3, the data register unit 11, the D/A converter 13, the output buffer unit 14, and the upper and lower grayscale voltage ranges can be readily understood by those skilled in the art, and therefore, their detailed descriptions will be omitted.

Although it has been described in this embodiment that the data voltage of the image data belongs to the lower grayscale voltage range when the grayscale range bit of the image data is ‘0,’ and the data voltage of the image data belongs the upper grayscale voltage range when the grayscale range bit of the image data is ‘1,’ the present invention is not limited thereto. Alternatively, the image data may be configured so that the data voltage of the image data belongs to the upper grayscale voltage range when the grayscale range bit of the image data is ‘0,’ and the data voltage of the image data belongs the lower grayscale voltage range when the grayscale range bit of the image data is ‘1.’

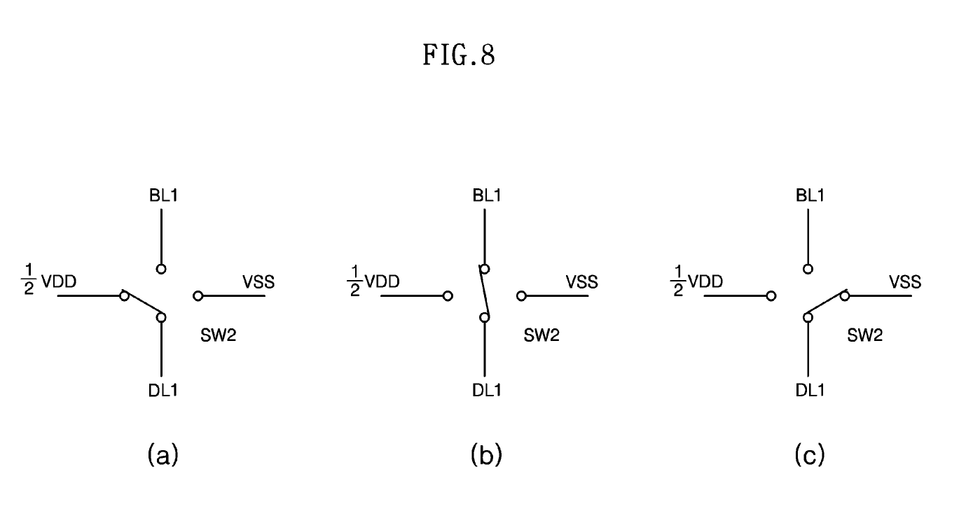

FIG. 8 is an exemplary view illustrating switching operations of the multiplexer unit. In FIG. 8, the maximum voltage is a power source voltage VDD, the minimum voltage is 0V, and the intermediate voltage is VDD/2. The multiplexer unit 16 includes a switch SW2 for pre-charging the data line DL1 by applying the intermediate voltage VDD/2 or ground voltage VSS to the data line DL1, or connecting the buffer output line BL1 of the output buffer unit 14 to the data line DL1.

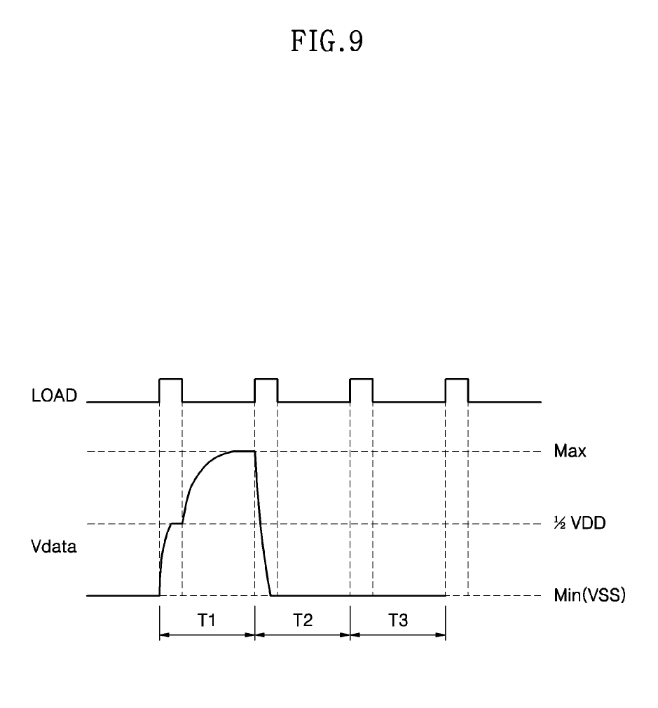

FIG. 9 is a waveform diagram showing a change in voltage applied to the data line when consecutive image data are inputted in the source driver according to the embodiment of the present invention. In FIG. 9, the consecutive image data illustrates that after image data with the minimum voltage Min is inputted, image data with the maximum voltage Max is inputted during period T1, the image data with the minimum voltage Min is inputted during period T2, and the image data with the minimum voltage Min is inputted during period T3.

Referring to FIG. 9, the data voltage of the image data is the maximum voltage Max in the period T1. Therefore, the MSB of the image data is 1.

The switching control unit 15 changes the switching control signal CLT into the first logic state ‘1’ based on the MSB 1 of the image data, and provides the changed switching control signal to the multiplexer unit 16. The multiplexer unit 16 pre-charges the data line DL1 by applying the intermediate voltage VDD/2 to the data line DL1 in response to the switching control signal CLT during the load signal enable period ‘H.’ The multiplexer unit 16 applies the maximum voltage Max that is the data voltage of the image data to the corresponding data line DL1 during the load signal disable period ‘L.’

Next, the data voltage of the image data is the minimum voltage Min in the period T2. Therefore, the MSB of the image data is 0.

The switching control unit 15 changes the switching control signal CTL into the second logic state ‘0’ based on the MSB 0 of the image data, and provides the changed switching control signal to the multiplexer unit 16. The multiplexer unit 16 pre-charges the data line DL1 by applying the ground voltage VSS to the corresponding data line DL1 in response to the switching control signal CTL during the load signal enable period ‘H.’ The multiplexer unit 16 applies the minimum voltage Min that is the data voltage of the image data to the corresponding data line DL1 during the load signal disable period ‘L.’

Next, the data voltage of the image data is the minimum voltage Min in the period T3. Therefore, the MSB of the image data is 0.

The switching control unit 15 changes the switching control signal CTL into the second logic state ‘0’ based on the MSB 0 of the image data, and provides the changed switching control signal to the multiplexer unit 16. The multiplexer unit 16 pre-charges the data line DL1 by applying the ground voltage VSS to the corresponding data line DL1 in response to the switching control signal CTL during the load signal enable period ‘H.’ The multiplexer unit 16 applies the minimum voltage that is the data voltage of the image data to the corresponding data line DL1 during the load signal disable period ‘L.’

According to this embodiment, it is possible to solve the problem that when consecutive image data belonging to the lower grayscale voltage range are inputted, the data voltage of the image data is unnecessarily pre-charged to the intermediate voltage, and therefore, power consumption and calorific value are increased.

As is apparent from the above description, the present invention provides a source driver output circuit of a flat panel display device, in which when a source driver outputs a data voltage for driving a display panel, the driver source omits a pre-charging operation and continuously maintains a previous level when the polarities of the data voltage are identical to each other, so that it is possible to reduce power consumption and calorific value.

The present invention also provides a source driver output circuit of a flat panel display device, in which when a source driver outputs a data voltage for driving a display panel, the driver source selects an intermediate voltage or ground voltage as a pre-charge voltage, so that it is possible to increase a slew rate and reduce power consumption and calorific value.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A source driver output circuit of a flat panel display device, comprising:
a first latch unit configured to receive image data from a data register unit and store the received image data;
a second latch unit configured to receive the image data from the first latch unit and store the received image data;
a D/A converter configured to convert the image data of the second latch unit into a data voltage;
an output buffer unit configured to output the data voltage of the D/A converter to a data line;
a switching control unit configured to decide whether or not the data voltages of two image data of the same channel among image data of horizontal lines adjacent to each other, stored in the first and second latch units, belong to the same grayscale voltage range, and output a switching control signal based on the decided result; and
a multiplexer unit configured to select a pre-charge voltage in response to the switching control signal and output the selected pre-charge voltage to the data line, or maintain a connection state between a corresponding channel of the output buffer unit and the corresponding data line, in place of selecting the pre-charge voltage.

2. The source driver output circuit of claim 1, wherein the grayscale voltage range comprises an upper grayscale voltage range between a maximum voltage and an intermediate voltage and a lower grayscale voltage range between the maximum voltage and a minimum voltage, and the intermediate voltage is a voltage between the maximum voltage and the minimum voltage.

3. The source driver output circuit of claim 2, wherein the intermediate voltage is the pre-charge voltage.

4. The source driver output circuit of claim 2, wherein the image data contains a grayscale range bit indicating whether the data voltage of the image data belongs to the upper grayscale voltage range or the lower grayscale voltage range, and the switching control unit decides whether or not the data voltages of the two image data belong to the same grayscale voltage range based on the grayscale range bit.

5. The source driver output circuit of claim 1, wherein the switching control unit generates the switching control signal by performing an Exclusive OR operation on the grayscale range bits of the two image data.

6. A source driver output circuit of a flat panel display device, comprising:
a latch unit configured to receive image data from a data register unit and store the received image data;
a D/A converter configured to convert the image data of the latch unit into a data voltage;
an output buffer unit configured to output the data voltage of the D/A converter to a data line;
a switching control unit configured to decide whether the data voltages of the image data stored in the latch unit belongs to an upper grayscale voltage range or a lower grayscale voltage range, and output a switching control signal based on the decided result; and
a multiplexer unit configured to select a first or second voltage as a pre-charge voltage and output the selected voltage to the data line, in response to the switching control signal.

7. The source driver output circuit of claim 6, wherein the upper grayscale voltage range is between a maximum voltage and an intermediate voltage, the lower grayscale voltage range is between a minimum voltage and the intermediate voltage, and the intermediate voltage is a voltage between the maximum voltage and the minimum voltage.

8. The source driver output circuit of claim 6, wherein the first voltage is the intermediate voltage and the second voltage is the minimum voltage.

9. The source driver output circuit of claim 6, wherein the image data contains a grayscale range bit indicating whether the data voltage of the image data belongs to the upper grayscale voltage range or the lower grayscale voltage range, and the switching control unit decides whether or not the data voltages of the two image data belong to the upper grayscale voltage range or the lower grayscale voltage based on the grayscale range bit.
